(19) United States
(12) Patent Application Publication
(10) Pub. No.: US 2018/0122079 A1
(43) Pub. Date: May 3, 2018

(54) SYSTEMS AND METHODS FOR DETERMINING HISTOGRAMS

(71) Applicant: QUALCOMM Incorporated, San Diego, CA (US)

(72) Inventor: Sujith Srinivasan, San Diego, CA (US)

(21) Appl. No.: 15/336,558

(22) Filed: Oct. 27, 2016

(51) Int. Cl. G06T 7/00; G06K 9/34

(52) U.S. Cl. CPC G06T 7/0081; G06K 9/34

(57) ABSTRACT

A method for determining a histogram is described. The method includes storing a plurality of histograms in a memory bank, each histogram corresponding to a group of pixels in a region of interest of an image. The method also includes initiating transfer of one or more histograms between the memory bank and a local memory. The method further includes finding, for an incoming pixel, weights of each bin for the one or more histograms stored in the local memory. The method additionally includes adding the weights to the one or more histograms stored in the local memory. The method also includes transferring one or more updated histograms from the local memory to the memory bank. The method further includes replacing a corresponding one or more histograms in the memory bank with the one or more updated histograms.

### FIELD OF DISCLOSURE

The present disclosure relates generally to electronic devices. More specifically, the present disclosure relates to systems and methods for determining histograms.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cameras, video camcorders, digital cameras, cellular phones, smart phones, computers, televisions, etc.) capture and/or utilize images. For example, a smartphone may capture and/or process still and/or video images. Processing images may demand a relatively large amount of time, memory and energy resources. The resources demanded may vary in accordance with the complexity of the processing.

An electronic device may generate histograms of image data for a variety of uses. It is beneficial to generate histograms that vary depending on configurable parameters. However, software implementations may be inadequate to generate histograms with varying parameters. As can be observed from this discussion, hardware implementations that are adaptable to generate histograms with varying parameters may be beneficial.

### SUMMARY

A method for determining a histogram is described. The method includes storing a plurality of histograms in a memory bank, each histogram corresponding to a group of pixels in a region of interest of an image. The method also includes initiating transfer of one or more histograms between the memory bank and a local memory. The method further includes finding, for an incoming pixel, weights of each bin for the one or more histograms stored in the local memory. The method additionally includes adding the weights to the one or more histograms stored in the local memory. The method also includes transferring one or more updated histograms from the local memory to the memory bank. The method further includes replacing a corresponding one or more histograms in the memory bank with the one or more updated histograms.

The method may also include encoding or decoding histogram data being transferred between the memory bank and the local memory. The method may also include determining which of the plurality of histograms stored in the memory bank are transferred to the local memory based on a row and column number of the incoming pixel.

The plurality of histograms stored in the memory bank may include one or more rows of histograms. Each row of histograms may correspond to a row of pixels in the region of interest of the image.

When the incoming pixel is at a beginning of a current group of pixels, one or more updated histograms currently stored in the local memory may be transferred to the memory bank and one or more histograms corresponding to the incoming pixel may be transferred from the memory bank to the local memory.

Finding weights of each bin for the one or more histograms stored in the local memory may include performing interpolation on the incoming pixel to compute the weights of each bin for the one or more histograms stored in local memory.

The method may also include initializing the memory bank at image boundaries. The method may also include reading out histogram data in the memory bank at cell boundaries or image boundaries.

An apparatus for determining a histogram is also described. The apparatus includes a memory bank that stores a plurality of histograms, each histogram corresponding to a group of pixels in a region of interest of an image. The apparatus also includes a processor having a local memory configured to receive one or more histograms from the memory bank. The processor is configured to initiate transfer of one or more histograms between the memory bank and the local memory. The processor is also configured to find, for an incoming pixel, weights of each bin for the one or more histograms stored in the local memory. The processor is further configured to add the weights to the one or more histograms stored in the local memory. The local memory transfers one or more updated histograms to the memory bank. The memory bank replaces a corresponding one or more histograms with the one or more updated histograms.

The apparatus may be adaptable to determine histograms of different cell size, number of bins, types of input, histogram weighting increments, or interpolation schemes. The apparatus may be used in color matching or object detection within the image.

Another apparatus for determining a histogram is described. The apparatus includes means for storing a plurality of histograms in a memory bank, each histogram corresponding to a group of pixels in a region of interest of an image. The apparatus also includes means for initiating transfer of one or more histograms between the memory bank and a local memory. The apparatus further includes means for finding, for an incoming pixel, weights of each bin for the one or more histograms stored in the local memory. The apparatus additionally includes means for adding the weights to the one or more histograms stored in the local memory. The apparatus also includes means for transferring one or more updated histograms from the local memory to the memory bank. The apparatus further includes means for replacing a corresponding one or more histograms in the memory bank with the one or more updated histograms.

### BRIEF DESCRIPTION OF THE DRAWINGS

FIG. 1 is a block diagram illustrating an electronic device configured to determine histograms;

FIG. 2 is a block diagram illustrating a configuration of a programmable histogram block;

FIG. 3 is an example illustrating an image divided into cells and corresponding histograms;

FIG. 4 illustrates examples of bilinear interpolation and trilinear interpolation;

FIG. 5 is a flow diagram illustrating a method for determining a histogram;

FIG. 6 is a flow diagram illustrating another method for determining a histogram;

FIG. 7 is a block diagram illustrating a hardware configuration for object detection using a programmable histogram block;

FIG. 8 is a block diagram illustrating a hardware configuration for color matching using a programmable histogram block; and

FIG. 9 illustrates certain components that may be included within an electronic device.

### DETAILED DESCRIPTION

An electronic device may generate histograms for a variety of uses. For example, an electronic device may use histograms to perform object detection, object re-identification and key point description. These operations may be useful for a variety of applications. For example, histograms may be used for navigation, safety and security applications. Histograms may also be used in other computer vision and image processing applications.

There are many different types of histograms that vary according to use-cases. Each type of histogram may have different parameters (e.g., cell size, number of bins, interpolation schemes) depending on the application.

The systems and methods described herein disclose a programmable histogram block that is configured to implement numerous types of histograms used in computer vision and image processing. The programmable histogram block is configurable to determine different types of histograms based on desired histogram parameters. The programmable histogram block may be implemented as a hardware block due to the high volume of data that needs to be processed. For example, high definition (HD) frames may be processed at 30 or 60 frames per second (fps). The systems and methods for determining histograms are explained in greater detail below.

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

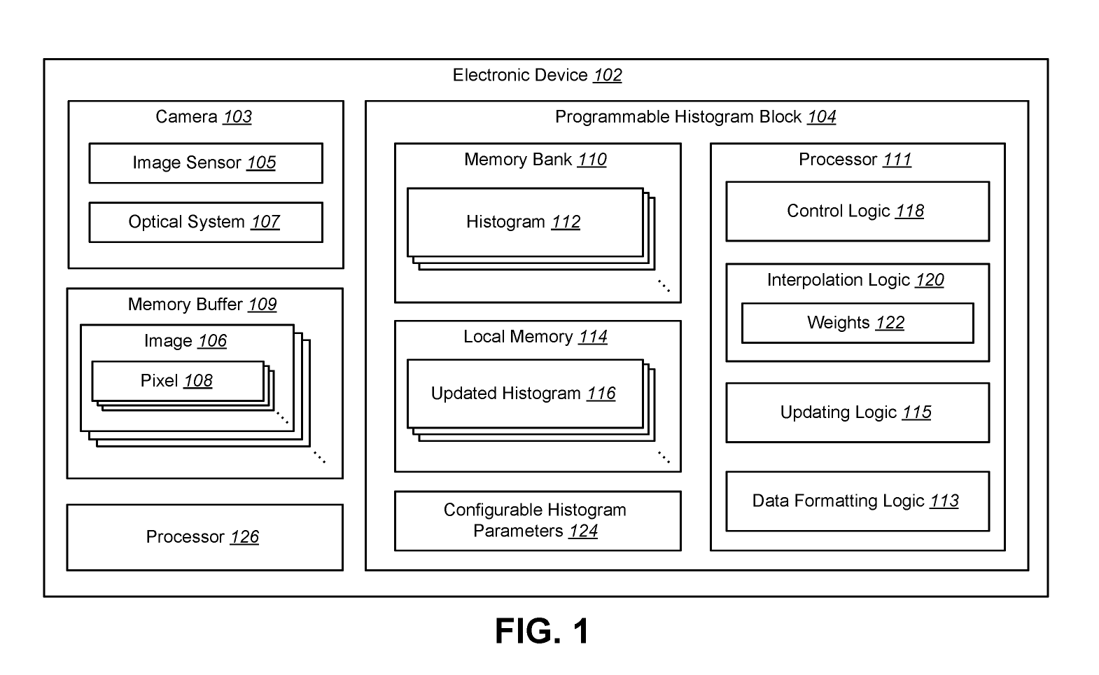

FIG. 1 is a block diagram illustrating an electronic device 102 configured to determine histograms 112. The electronic device 102 may also be referred to as a wireless communication device, a mobile device, mobile station, subscriber station, client, client station, user equipment (UE), remote station, access terminal, mobile terminal, terminal, user terminal, subscriber unit, etc. Examples of electronic devices include laptop or desktop computers, cellular phones, smart phones, wireless modems, e-readers, tablet devices, gaming systems, security systems, robots, aircraft, unmanned aerial vehicles (UAVs), automobiles, etc. Some of these devices may operate in accordance with one or more industry standards.

In many scenarios, the electronic device 102 may determine histograms 112 for one or more images 106 in an image sequence. In an implementation, an electronic device 102 may include one or more cameras 103. A camera 103 may include an image sensor 105 and an optical system 107 (e.g., lenses) that focuses images of objects that are located within the field of view of the optical system 107 onto the image sensor 105. An electronic device 102 may also include a camera software application and a display screen. When the camera application is running, images 106 of objects that are located within the field of view of the optical system 107 may be recorded by the image sensor 105. The captured images 106 may be stored in a memory buffer 109.

In some implementations, the camera 103 may be separate from the electronic device 102 and the electronic device 102 may receive image data from one or more cameras 103 external to the electronic device 102. In yet another implementation, the electronic device 102 may receive image data from a remote storage device.

To capture the image 106, an image sensor 105 may expose image sensor elements to the image scene to capture the image 106. The image sensor elements within image sensor 105 may, for example, capture intensity values representing the intensity of the light of the scene at a particular pixel position. In some cases, each of the image sensor elements of the image sensor 105 may only be sensitive to one color, or color band, due to the color filters covering the image sensor elements. For example, the image sensor 105 may comprise, for example, an array of red, green and blue filters. The image sensor 105 may utilize other color filters, however, such as cyan, magenta, yellow and key (CMYK) color filters. Thus, each of the image sensor elements of image sensor 105 may capture intensity values for only one color. Thus, the image information may include pixel intensity and/or color values captured by the image sensor elements of image sensor 105.

Although the present systems and methods are described in terms of captured images 106, the techniques discussed herein may be used on any digital image. For example, the images 106 may be frames from a video sequence. Therefore, the terms video frame and digital image may be used interchangeably herein.

Histograms 112 are used extensively in image processing and computer vision. For example, histograms 112 may be used for object detection, object tracking, and key point description. These applications are useful for automotive applications (e.g., autonomous driving) and security cameras.

There are many types of histograms 112 such as gradient histograms, intensity histograms and color histograms. Gradient histograms are characterized by a magnitude and orientation (e.g., angle) of a pixel 108 in an image 106. Here, “gradient” means the edge of the pixels 108. Gradient histograms may be used for object detection and to match key points from two images 106.

Color histograms may be used for color identification. For example, color histograms may be used for panel matching or for image registration. These are some of the many examples of how a histogram 112 may be used.

Different use-cases demand histograms 112 of different parameters. Histograms 112 for one use-case may not be exactly the same as histograms 112 for another use-case. For example, an application may use its own type of histogram 112 with parameters that differ from those of another application.

Gradient histograms are histograms 112 of the edge properties of each pixel 108. Intensity histograms are histograms 112 of brightness of the pixels 108. Color histograms are histograms 112 of the entire red, green, blue (RGB) channel or a channel of some other color space, (e.g., like LUV or HSV).

These different types of histograms 112 have different parameters. For example, histograms 112 may differ in localization parameters (e.g., cell size), the number of bins, the weight that is used to increment the histogram 112 and interpolation schemes.

The cell size of a histogram 112 relates to the number of pixels 108 in a histogram 112. An image 106, or a region of interest of the image 106, may be divided into non-overlapping regions called cells. The size of the cell can be expressed as the number of pixels 108 in a row and column of the cell. For example, a cell may be 8×8 pixels, 16×16, 32×32, etc.

A histogram 112 may be divided into a number of bins. The range of values of a variable may be divided into a series of intervals. The bins may be consecutive non-overlapping intervals of the variable. In the case of image processing, the bins may represent different pixel 108 properties. The number of bins in a histogram 112 may be configurable for different histogram types and uses.

A weight may be used to increment the histogram 112. In a simple case, a particular pixel 108 would increment 1 to a particular bin. In more complicated cases (e.g., computer vision applications), instead of incrementing 1, some magnitude may be added, which is a function of the pixel 108. For example, pixels 108 with a strong edge would add a large magnitude, and pixels 108 with a very weak edge would add a small magnitude.

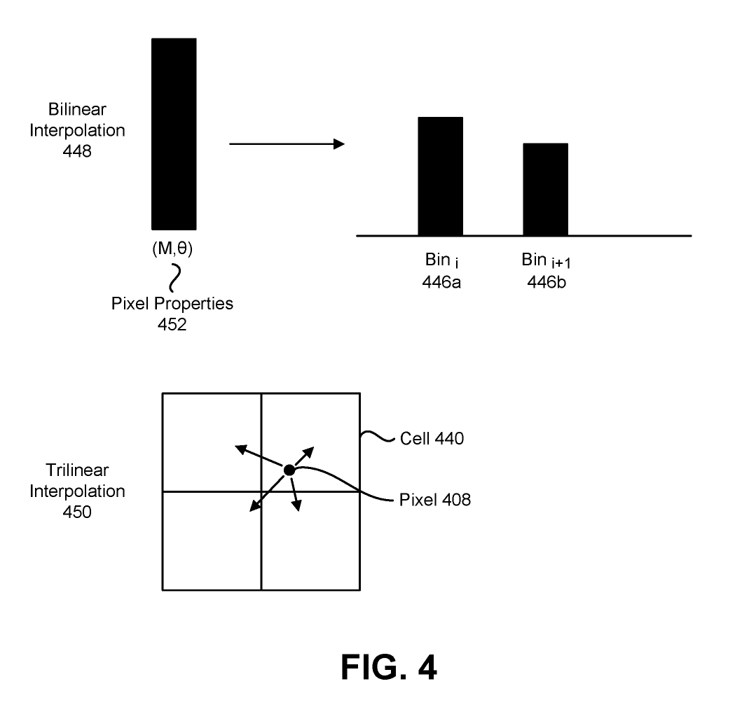

Different interpolation schemes may be used. Interpolation acts as a smoothing function to distribute the weight of a pixel 108 into two or more bins when a pixel 108 does not fall at the center of one bin. Examples of interpolation schemes include bin interpolation (also referred to as bilinear interpolation) and spatial interpolation (also referred to as trilinear interpolation). These interpolation schemes are described in more detail in connection with FIG. 4.

As observed by this discussion, the parameters may change from one type of histogram 112 to another. Furthermore, the same type of histogram 112 may have different parameters (e.g., cell size, bin number) from one use to another. However, these varying parameters are difficult to implement in software and hardware. Histogram generation may have demanding performance requirements. In particular, histograms 112 may need to be generated at a very high rate. For example, histograms 112 may be generated for a stream of full HD frames and also multiple scales of these HD frames. In this case, the throughput is high.

In software implementations, the performance degrades if certain parameters are not suitable for the processor core that is being used for implementation. For some parameters, a software implementation may provide good performance, but for other parameters, the performance (e.g., speed and power consumption) may decrease considerably. Therefore, in software, the code can be changed to generate different histograms 112, but performance may be an issue when dealing with large frame sizes and frame rates for certain choices of parameters.

In hardware implementations, a large number of parameters need to be taken into consideration to successfully design a histogram block that can be used for multiple use cases. In one hardware approach, a histogram block may be built that supports only specific types of histograms 112 (e.g., a histogram of gradients (HOG)). However, this approach is constrained to the limited types of histograms 112 for which it is designed.

The described systems and methods provide a programmable histogram block 104. This is a customized hardware solution for generating histograms 112 for different use cases. The programmable histogram block 104 may interface with other hardware blocks to drive data in and out. Alternatively, the programmable histogram block 104 may interface with an external processor 126 to feed data into it and read data out of the processor 126.

The programmable histogram block 104 may be designed to support numerous configurations. In an implementation, the programmable histogram block 104 may have a number of configurable histogram parameters 124. These configurable histogram parameters 124 may include the type of histogram 112 (e.g., gradient, color, intensity). The configurable histogram parameters 124 may also include the type of input (e.g., pixel property), the cell size, number of bins, histogram weighting increments, and interpolation scheme (e.g., bin or spatial interpolation).

The programmable histogram block 104 may include a memory bank 110. In an implementation, the memory bank 110 may be static random-access memory (SRAM). The memory bank 110 may store a plurality of histograms 112. Each of the stored histograms 112 may correspond to a group of pixels 108 in a region of interest of an image 106.

Histograms 112 may be generated for a portion of the image 106. This portion is referred to herein as a region of interest. The region of interest may include a subset of the pixels 108 in the image 106. Alternatively, the region of interest may include all of the pixels 108 in the image 106.

As used herein, a group of pixels 108 may be referred to as a cell. Therefore, a given histogram 112 stored in the memory bank 110 may correspond to a certain cell of pixels 108.

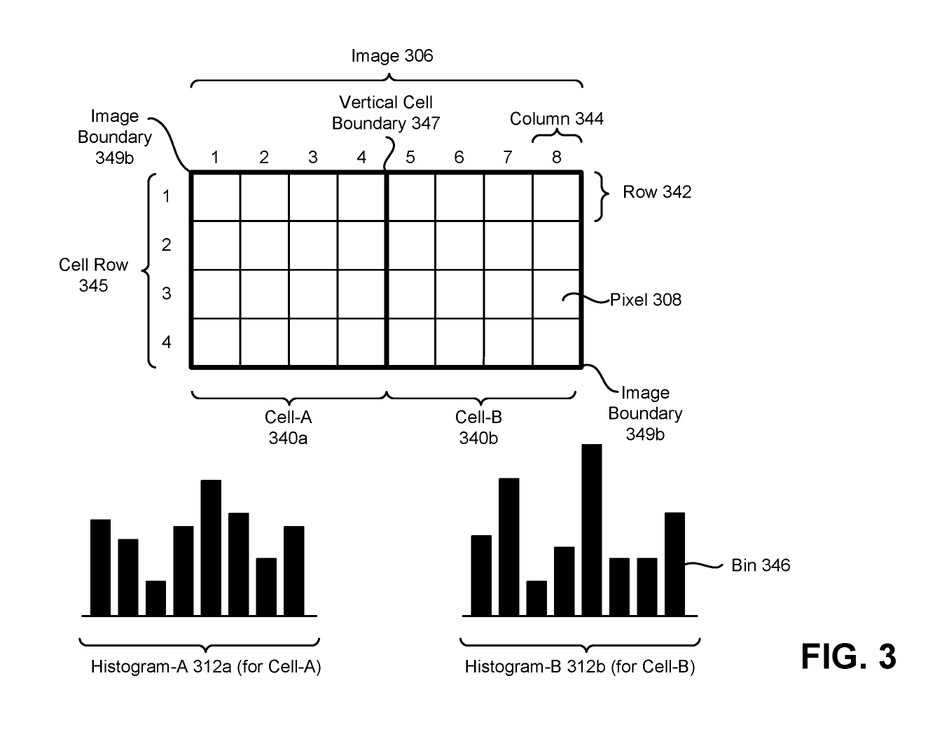

The memory bank 110 may store histograms 112 in a long-term fashion as the histograms 112 are generated from a stream of pixel 108 data. In an implementation, the memory bank 110 may store one or more rows of histograms 112. A row of histograms 112 may correspond to a row of cells in the region of interest of the image 106. An example of a row of cells is described in connection with FIG. 3.

The programmable histogram block 104 may also include local memory 114. The local memory 114 may also be referred to as local storage. The local memory 114 may store histograms that are currently being updated. These histograms are referred to as updated histograms 116 or local histograms.

Using a separate memory bank 110 and local memory 114 may provide benefits. The memory bank 110 is a long term storage of histograms 112 of a row(s) of cells in an image 106. The memory bank 110 may be implemented using SRAM. However, during the update process, only a small number of histograms 112 would change, and it is convenient to have access to the changing histograms 112. These histograms 112 may be read out of the memory bank 110 and stored locally in the local memory 114 so that the histograms 112 are easy to modify. In an implementation, the local memory 114 may use flip-flops or registers. SRAMS have some constraints when reading/writing the contents of multiple cells and, therefore, a register-based local storage may be beneficial. Both of the memory bank 110 and local memory 114 may be on-chip.

The local memory 114 may receive one or more histograms 112 from the memory bank 110. In an implementation, the number of histograms that are received from the memory bank 110 is based on the interpolation scheme that is configured. For example, if bin (i.e., bilinear) interpolation is configured, then the local memory 114 may receive one histogram 112 corresponding to the cell of the incoming pixel 108. If spatial (i.e., trilinear) interpolation is configured, then the local memory 114 may receive up to four histograms 112 corresponding to the cell of the incoming pixel 108 and up to three neighboring cells.

The programmable histogram block 104 may also include interpolation logic 120. The interpolation logic 120 may be implemented as hardware (e.g., circuitry), software implemented by a processor 111 or a combination of hardware and software.

The interpolation logic 120 may receive an incoming pixel 108. The interpolation logic 120 may then perform the configured interpolation scheme (e.g., bin interpolation or spatial interpolation) to find the weights 122 of each bin in each local histogram (i.e., updated histogram 116) for the current pixel 108.

Updating logic 115 may add the weights 122 determined by the interpolation logic 120 to the one or more updated histograms 116 stored in the local memory 114. For example, the updating logic 115 may receive the weights 122 calculated by the interpolation logic 120. The updating logic 115 may add the weights 122 to corresponding bins of the one or more updated histograms 116 stored in the local memory 114. Therefore, the local memory 114 stores one or more histograms 116 that are updated by the interpolation logic 120. The updating logic 115 may be implemented as hardware (e.g., circuitry), software implemented by a processor 111 or a combination of hardware and software.

The programmable histogram block 104 may also include control logic 118. The control logic 118 may be implemented as hardware (e.g., circuitry), software implemented by a processor 111 or a combination of hardware and software.

The control logic 118 may read out histograms 112 and initialize the memory bank 110 at image boundaries. The image 106 may be characterized by different boundaries. A vertical cell boundary is the boundary between two cells in a row of cells. A vertical cell boundary occurs before the first pixel 108 at the beginning of a row of pixels 108 within a cell and after the last pixel 108 at the end of a row of pixels 108 within a cell.

An image boundary is the boundary at the beginning and end of a row of cells. An image boundary occurs before the first pixel 108 in the first cell of a row of cells. An image boundary also occurs after the last pixel 108 in the last cell of a row of cells.

If the image boundary is after a vertical cell boundary, then the control logic 118 may read out the row of histograms 112 that will not need to be updated any further. For example, the control logic 118 may provide the completed histograms 112 to the processor 126 or other hardware components.

The control logic 118 may also initialize the current row of histograms 112 in the memory bank 110 to zeros if the image boundary is after a vertical cell boundary. Additionally, for a new image 106, the control logic 118 may initialize the row of histograms 112 in the memory bank 110 to zeros.

The control logic 118 may configure the memory bank 110 according to the configurable histogram parameters 124. For example, the control logic 118 may configure the memory bank 110 with the number and size of histograms 112 to be stored based on the configurable histogram parameters 124. The control logic 118 may assign addresses to the histograms 112 stored by the memory bank 110.

The control logic 118 may initiate transfer of histograms 112 and updated histograms 116 between the memory bank 110 and local memory 114. For example, the control logic 118 may receive a row and column number for each pixel 108 in the region of interest of the image 106. The control logic 118 may determine when a histogram 112 stored in the memory bank 110 is transferred to the local memory 114 and when an updated histogram 116 stored in the local memory 114 is transferred to the memory bank 110.

Data formatting logic 113 may decode and encode histogram data being transferred between the memory bank 110 and the local memory 114. The data formatting logic 113 may be implemented as hardware (e.g., circuitry), software implemented by a processor 111 or a combination of hardware and software.

To decode (i.e., read the histograms 112 from the memory bank 110 to the local memory 114), the data formatting logic 113 may receive a stream of N bits from the memory bank 110 corresponding to one or more selected histograms 112 to be updated in the local memory 114. The data formatting logic 113 may output P bins each of Q bits, where P and Q are variable. The data formatting logic 113 may format the histogram data from the memory bank 110 and may put the histogram data into the local memory 114.

It should be noted that because configurable histogram parameters 124 are flexible, the number of bits to store a row of histograms 112 is quite variable. The data formatting logic 113 may make sense of the bit stream to accurately provide the histograms 112 to the local memory 114.

The data formatting logic 113 may also encode histogram data (i.e., write updated histogram(s) 116 back to the memory bank 110). In this case, the data formatting logic 113 may pack all bits from the updated histogram(s) 116. These bits may be stored in the address for the corresponding histogram(s) 112 in the memory bank 110.

For every incoming pixel 108, the control logic 118 may determine if the pixel 108 is at the beginning of a new cell (i.e., at the beginning of a current group of pixels 108). In this case, this indicates that the local memory 114 and interpolation logic 120 have finished updating the histograms 116 for the previous cell. The control logic 118 initiates the transfer of the updated histogram(s) 116 from the local memory 114 back to the memory bank 110. The local memory 114 may transfer the one or more updated histograms 116 to the memory bank 110. The memory bank 110 may replace a corresponding one or more histograms 112 with the one or more updated histograms 116.

Additionally, if the control logic 118 determines that the incoming pixel 108 is at the beginning of a new cell, the control logic 118 may fetch one or more new histograms 112 (that correspond to the incoming pixel 108) from the memory bank 110 and transfer the one or more new histograms 112 to the local memory 114.

For every incoming pixel 108, the interpolation logic 120 may perform interpolation to compute the weights 122 of each bin of the updated histogram(s) 116 in the local memory 114. The local memory 114 may add the computed weights 122 to the updated histograms 116.

The histogram data that is read out of the memory bank 110 may be provided to the processor 126 or other hardware components. The programmable histogram block 104 may be combined with common pre- and post-processing functions. These functions may include normalization, gradient filters, color space converters, and rectangular-polar conversion. These functions may also include finding a maximum, mode or moments of a histogram 112. The histograms 112 for each cell may be combined or concatenated to generate a histogram for an image 106 or region of interest.

In an implementation, the programmable histogram block 104 may be combined with additional logic blocks (e.g., rectangular-to-polar (R2P) and normalization). These blocks may form custom hardware that would interface with the processor 126. The processor 126 may receive image 106 data from the memory buffer 109 and send pixels 108 to the programmable histogram block 104. The processor 126 may receive the histogram data outputs from the programmable histogram block 104 and use this for any application that may rely on histogram data. In this way, the processor 126 may save time and power by using a programmable histogram block 104 that is optimized for histogram 112 generation.

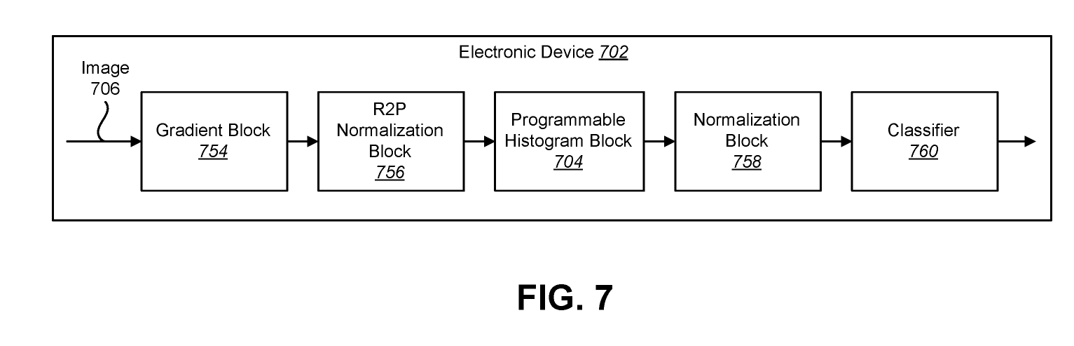

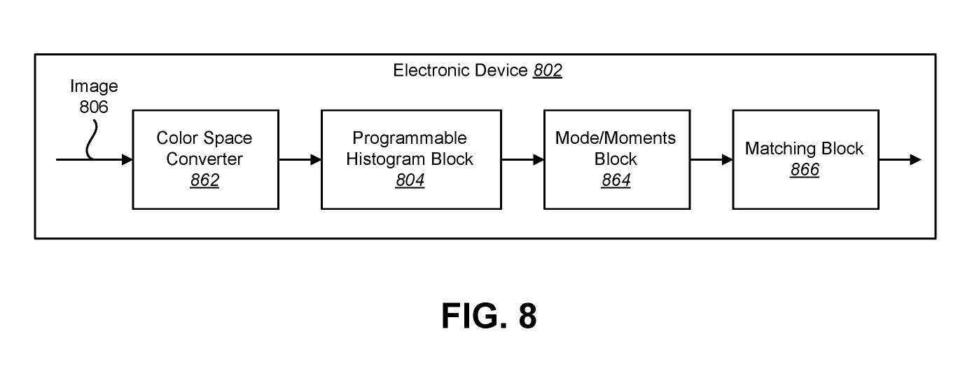

In other implementations, the programmable histogram block 104 may be included in a hardware configuration. An example of a hardware configuration for object detection using a programmable histogram block 104 is described in connection with FIG. 7. An example of a hardware configuration for color matching using a programmable histogram block 104 is described in connection with FIG. 8.

The described systems and methods provide a flexible hardware approach to generating a variety of histograms 112. The programmable histogram block 104 can be designed to support numerous configurations of histograms 112. The programmable histogram block 104 can either interface with other hardware blocks or the programmable histogram block 104 can interface with a processor 126. Furthermore, the programmable histogram block 104 may be combined with other functions that are associated with histograms 112 (e.g., normalization, rectangular-to-polar conversion, etc.). Adding these functions may reduce the load on the processor 126.

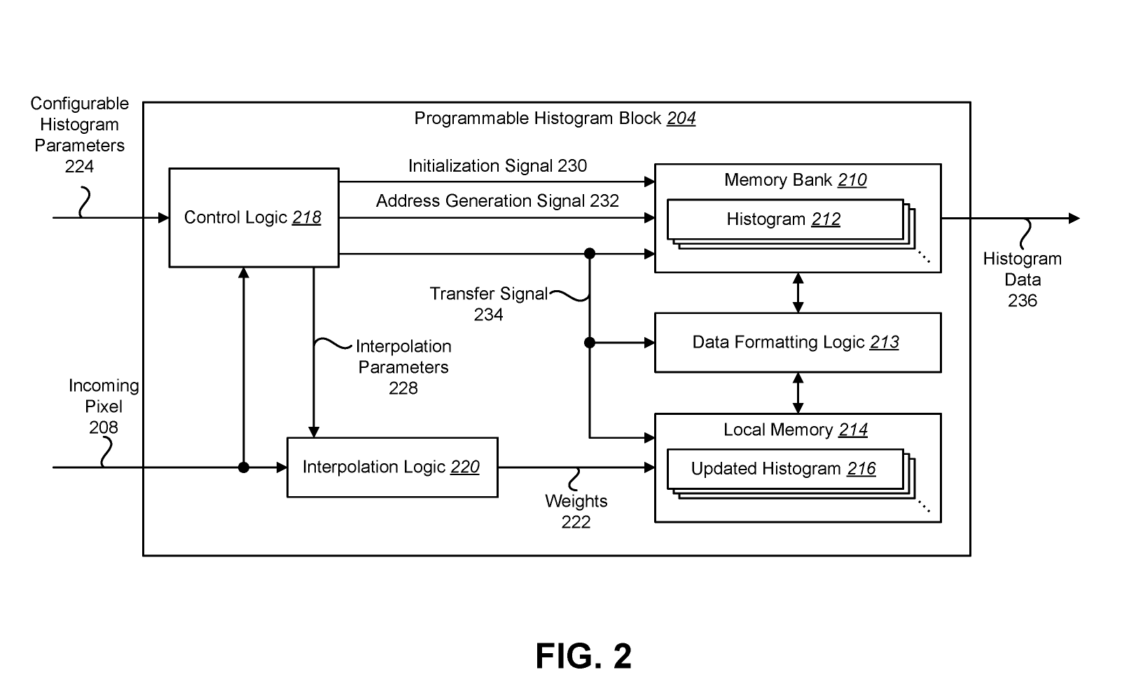

FIG. 2 is a block diagram illustrating a configuration of a programmable histogram block 204. The programmable histogram block 204 may be implemented in accordance with the programmable histogram block 104 described in connection with FIG. 1. For example, the programmable histogram block 204 may be included in an electronic device 102.

In an implementation, the control logic 218 may receive configurable histogram parameters 224. The configurable histogram parameters 224 may indicate the configuration of the histograms 212 that the programmable histogram block 204 generates. For example, the programmable histogram block 204 may be adaptable to determine histograms 212 of different cell size, number of bins, types of input, histogram weighting increments, or interpolation schemes. An example of configurable histogram parameters 224 is provided in Table 1.

TABLE 1

| | | | |
|---|---|---|---|
| Histogram Type | Gradient | Color | Intensity |
| Inputs | Magnitude/Angle | Saturation/Hue | Intensity |
| Cell size | 4 × 4, 8 × 8, | 8 × 8 and | 8 × 8 and above |
| | 16 × 16 | above | |
| Number of bins | 6, 9, 18 | 6, 9, 18 | 4, 8, 16, 32 |
| Number of | Up to 2 | 1 | Up to 3 |
| histograms | | | |
| What to add | Magnitude | Saturation | 1 |
| Which bin | Based on angle | Based on hue | Based on MSB |
| | | angle | |
| Bilinear | Yes | Yes | Yes |
| Interpolation | | | |
| Normalization | Yes | No | No |

Table 2 illustrates configurable histogram parameters 224 that may be used for different gradient histograms: normal HOG, aggregate channel features (ACF) HOG, and FHOG.

TABLE 2

| | | | |
|---|---|---|---|
| Histogram Type | Normal HOG | ACF HOG | FHOG |
| Inputs | Magnitude/ | Magnitude/Angle | Magnitude/Angle |
| | Angle | | |
| Cell size | 8 × 8 | 4 × 4 | 8 × 8 |
| Number of bins | 9 | 6 | 9 and 18 |
| Number of | 1 | 1 | 2 |
| histograms | | | |
| Normalization | Yes | No | Yes |
| Dimensionality | No | No | Yes |
| reduction | | | |

Upon receiving the configurable histogram parameters 224, the control logic 218 may configure the memory bank 210, the data formatting logic 213, interpolation logic 220 and local memory 214 to accommodate the indicated histograms 212. For example, the control logic 218 may indicate the cell size to the memory bank 210. The control logic 218 may also allocate an amount of memory in the memory bank 210 to accommodate a row of histograms 212.

The control logic 218 may send an address generation signal 232 to the memory bank 210. The address generation signal 232 may assign a memory address for each histogram 212 stored in the memory bank 210. An address generator may be part of the control logic 218. The address generator may compute the histogram addresses of (e.g., 4 histograms) that have to be updated depending on the incoming pixel's location (e.g., row and column).

The control logic 218 may configure the local memory 214 and interpolation logic 220 based on the interpolation scheme. For example, if bin interpolation is used, the local memory 214 may be configured to store one updated histogram 216. If spatial interpolation is used, the local memory 214 may be configured to store up to four updated histograms 216. The interpolation logic 220 may be configured to perform interpolation accordingly.

The control logic 218 may send an initialization signal 230 to the memory bank 210. The initialization signal 230 may initialize the histograms 212 in the memory bank 210 at image boundaries. For example, upon receiving the initialization signal 230, the memory bank 210 may set the histograms 212 to zeros.

The control logic 218 may provide interpolation parameters 228 to the interpolation logic 220. The interpolation parameters 228 may configure the interpolation logic 220 according to the configurable histogram parameters 224. For example, the interpolation parameters 228 may indicate the interpolation scheme (e.g., bin interpolation or spatial interpolation).

The interpolation parameters 228 may also indicate characteristics of the bins. For example, the interpolation parameters 228 may include the bin centers, inverse differences of the bins and/or distances between the bins. In an example, a bin center may be the angle of that bin. Assuming that the bin angles may be from 0 degrees to 180 degrees, and the user wants 9 bins, this means that every bin is 20 degrees wide. The bin centers may be defined at 10 degrees, 30 degrees, 50 degrees and so forth.

The interpolation logic 220 and control logic 218 may receive an incoming pixel 208. The control logic 218 may determine whether to initiate a transfer of the histogram(s) 212 from memory bank 210 and the updated histograms 216 from the local memory 214 based on the row and column number of the incoming pixel 208. If the incoming pixel 208 is at the beginning of a new cell, then the control logic 218 may send a transfer signal 234 to the memory bank 210, data formatting logic 213 and local memory 214 to initiate a transfer of the updated histograms 216 to the memory bank 210. The transfer signal 234 may also initiate transfer of the new histograms 212 (that correspond to the incoming pixel 208) from the memory bank 210 to the local memory 214.

The incoming pixel 208 may include certain pixel properties depending on which histogram type is selected. For example, for gradient histograms, the input from the incoming pixel 208 may be magnitude (M) and angle (θ). For color histograms, the input from the incoming pixel 208 may be saturation and hue. For intensity histograms, the input from the incoming pixel 208 may be intensity.

The interpolation logic 220 may perform interpolation on the incoming pixel 208 to calculate weights 222 for bins in the one or more updated histograms 216. This may be accomplished as described in connection with FIG. 4. The local memory 214 may add the weights 222 to the corresponding bins in the one or more updated histograms 216.

In the case of bin interpolation, the interpolation logic 220 calculates weights 222 for the bins of a single updated histogram 216. In the case of spatial interpolation, the interpolation logic 220 calculates weights 222 for the bins of up to four updated histograms 216.

When the control logic 218 determines that an image boundary or image boundary has been reached, the control logic 218 may cause the histogram data 236 in the memory bank 210 to be read out. The control logic 218 may then re-initialize the memory bank 210 using an initialization signal 230.

FIG. 3 is an example illustrating an image 306 divided into cells 340 and corresponding histograms 312a-b. In this example, an image 306 is made up of a number of pixels 308. The pixels 308 may be in columns 344 and rows 342. Therefore, a given pixel 308 may be indicated by a certain column number and row number.

The image 306 or a region of interest may be divided into cells 340. Each cell may include a number of pixels 308. In this example, the cell size is 4×4 pixels 308. A vertical cell boundary 347 occurs before the first pixel 308 at the beginning of a row 342 of pixels 308 within a cell 340 and after the last pixel 308 at the end of a row 342 of pixels 308 within a cell 340. For cell-A 340a, a vertical cell boundary 347 occurs before the pixels 308 in column 1 and after the pixels 308 in column 4.

An image boundary 349 is the boundary at the beginning and end of a cell row 345. In this example, an image boundary 349a occurs before the first pixel 308 in cell-A 340a. An image boundary 349b also occurs after the last pixel 308 in cell-B 340b.

A histogram 312 may be generated for each cell 340. Histogram-A 312a is generated for cell-A 340a. Histogram-B 312b is generated for cell-B 340b. Therefore, each cell 340 may have a unique histogram 312.

The histograms 312 may include a configurable number of bins 346. In this example, the histograms 312 include 8 bins.

The histograms 312a-b may be generated as described in connection with FIG. 1. For example the memory bank 110 may store histograms 312 of a complete row 345 of cells 340. In an example, an image 306 may be 1920×1080 pixels 308 and the cell size may be 4×4. This means for the first four rows 342 of pixels 308, the number of histograms 312 stored in the memory bank 110 for a row 345 of cells is 1920÷4=480. In this example, the programmable histogram block 104 may generate histograms 312 using bin interpolation.

In a first step for bin interpolation (assuming there is no spatial interpolation), the 480 histograms 312 may be initialized to zero. Now, when the first pixel 308 comes, the first histogram 312 is moved from the memory bank 110 to the local memory 114, because that is the histogram 312 corresponding to the first pixel 308. Then, for the first 4 pixels 308, the histogram 312 is updated in the local memory 114 using the interpolation logic 120.

Once the fifth pixel is reached (upon crossing the vertical cell boundary 347), the histogram 312 corresponding to cell-A 340a should not be updated any more. The updated histogram 312 for cell-A 340a is written back to the memory bank 110. The second histogram 312 corresponding to cell-B 340b is then written to the local memory 114 and weights 122 added for the next four pixels 308. This process may continue until the last pixel 308 in the first row 342.

After the first row 342 of pixels 308, the next incoming pixel 308 is in the second row 342. For the incoming pixel 308 in the second row 342, the programmable histogram block 104 again goes back to the first histogram 312 in the memory bank 110. The first histogram 312 already has some values corresponding to the first four pixels 308 of the first row 342, but now for the second row 342, this histogram 312 is put in local memory 114 and updated for the first four pixels 308 of the second row 342. The first histogram 312 is then put back into the memory bank 110 and the second histogram 312 for pixels 5 through 8 in the second row 342 is updated in the local memory 114, and so on.

Therefore, the programmable histogram block 104 does not create a histogram 312 all at once. Instead, the programmable histogram block 104 creates a histogram 312 by row 342. The programmable histogram block 104 takes a histogram 312 out for the first row 342 per cell 340, updates the histogram 312 in local memory 114 and then puts the updated histogram 312 back into the long-term storage of the memory bank 110. The histograms (i.e., updated histogram 116) stored in the local memory 114 are the ones being updated for the incoming pixels 308.

Once the programmable histogram block 104 reaches an image boundary 349 (e.g., after the last pixel 308 in the last cell 340), the programmable histogram block 104 can read out the histograms 312 for that row 345 of cells 340. In this case, this occurs only after 4 rows 342 of pixels 308 are over. The memory block 110 may then be initialized to zeros and the process may start again for the next row 345 of cells 340.

As mentioned, this is an example of bin interpolation. When spatial interpolation is used, this process becomes more complicated. For example, the memory bank 110 may store multiple rows of histograms 312 corresponding to a row 345 of cells 340 in the region of interest of the image 306. In this case, up to four histograms 312 are updated for each incoming pixel 308. The four histograms 312 are spread across 2 rows of histograms 312. Therefore, the memory bank 110 needs to store at least 2 rows of histograms 112. However, the same process may be followed for reading histograms 312 from the memory bank 110, updating the histograms 312 in the local memory 114 and storing the updated histograms 312 back in the memory bank 110.

FIG. 4 illustrates examples of bilinear interpolation 448 and trilinear interpolation 450. Bilinear interpolation 448 may also be referred to as bin interpolation. Trilinear interpolation 450 may also be referred to as spatial interpolation. Interpolation logic 120 may be configured to use bilinear interpolation 448 or trilinear interpolation 450 based on configurable histogram parameters 124.

For bilinear interpolation 448, interpolation is performed between bins 446. In this example, the pixel properties 452 are expressed as a magnitude (M) and an angle (θ). Also, in this example, it is assumed that there are only 9 bins 446 in a histogram 112. In this case, the angle (θ) for a given pixel 408 may contain from 0 to 180 degrees or 0 to 360 degrees. The angle (θ) can be any number. If θ does not fall in the center of one of these 9 bins 446, then with bilinear interpolation 448 the two closest bins 446 may be found, which are on either side of θ. The magnitude of the pixel 408 may be split proportionally into weights 122. The weights 122 may be added to these two adjacent bins 446.

In this example, the two adjacent bins 446 are designated as Binᵢ 446a and Binᵢ₊₁ 446b. The magnitude (i.e., weight 122) for Binᵢ 446a is calculated as

$${M}_{i} = M \frac{{θ}_{i + 1} - θ}{{θ}_{i + 1} - {θ}_{i}} ,$$

where θᵢ is the bin center for Binᵢ 446a and θᵢ₊₁ is the bin center for Binᵢ₊₁ 446b. The magnitude for Binᵢ₊₁ 446b is calculated as

$${M}_{i + 1} = M \frac{θ - {θ}_{i}}{{θ}_{i + 1} - {θ}_{i}} .$$

Another type of interpolation is trilinear interpolation 450. With trilinear interpolation 450, for every pixel 408 multiple histograms 112 are update according to its position. Therefore, not only is the histogram 112 of the cell 440 of a given pixel 408 updated, up to three neighboring histograms 112 may be updated. This is because if the position of the edge changes, that edge might go into the next histogram 112. This may be a drastic change. To make that change more gradual, multiple histograms 112 are updated for every pixel 408 via the trilinear interpolation 450.

The interpolation logic 120 may work out different weights 122 for each cell 440 and each bin 446, and these updated histograms 116 are the set of histograms 112 that need to be updated for a given pixel 408. For every pixel 408, depending on its position, the programmable histogram block 104 may read out the corresponding histograms 112 from the memory bank 110 and write them to the local memory 114.

For trilinear interpolation 450, the programmable histogram block 104 may transfer histograms 112 and updated histograms 116 between the memory bank 110 and the local memory 114 at the cell boundary 347. Additionally, these transfers may occur at half the cell boundary 347. Whenever the pixel 408 crosses the cell 440 at half the cell boundary 347, then a new set of histograms 112 is needed. The control logic 118 figures out that the pixel 408 position has changed and determines which histograms 112 to transfer from the memory bank 110.

In this example, the pixel 408 is located toward the bottom left side of the cell 440. Therefore, the histograms 112 for the cells 440 to the left and below are also updated. But once the pixel 408 moves to the right side of the cell 440, then the histograms 112 on the left are no longer updated and histograms 112 on the right will be updated. Assuming the cell 440 is 8 pixels wide, for the first 4 pixels, the left histograms 112 are updated. For the second group of 4 pixels, the histograms 112 on the right are updated.

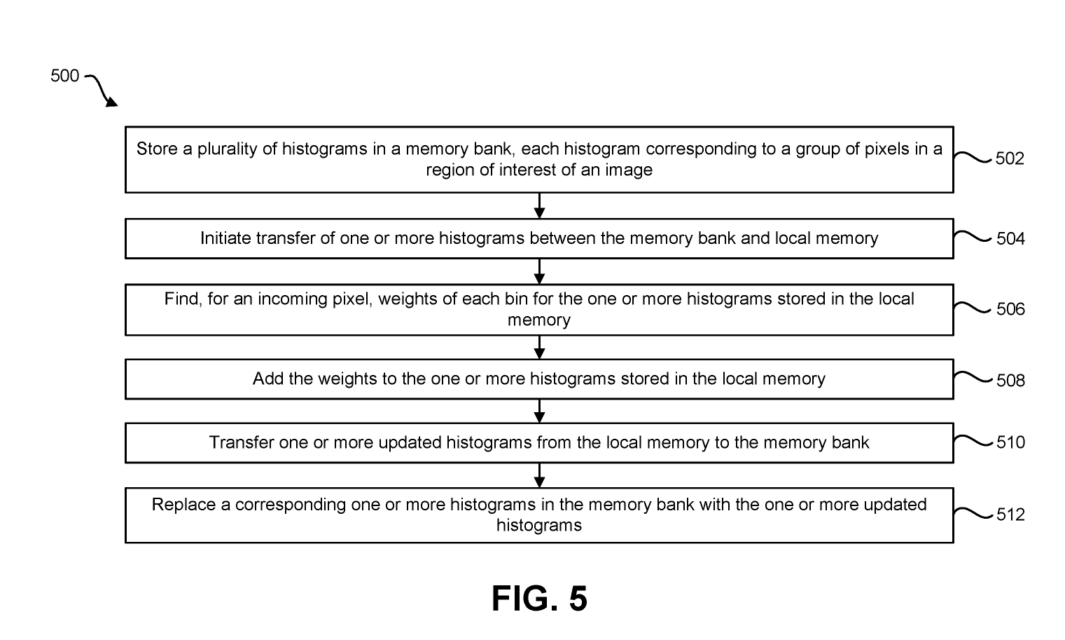

FIG. 5 is a flow diagram illustrating a method 500 for determining a histogram 112. The method 500 may be implemented by an electronic device 102. For example, the method 500 may be implemented by a programmable histogram block 104 of the electronic device 102.

The electronic device 102 may be adaptable to determine histograms 112 of different cell size, number of bins, types of input, histogram weighting increments, or interpolation schemes. For example, the electronic device 102 may be configured to perform bin interpolation or spatial interpolation. The electronic device 102 may be used in color matching or object detection within an image 106.

The electronic device 102 may store 502 a plurality of histograms 112 in a memory bank 110. Each histogram 112 may correspond to a group of pixels 108 in a region of interest of an image 106. The group of pixels 108 may be a cell 340 that includes a number of pixels 108 in rows 342 and columns 344.

The plurality of histograms 112 stored in the memory bank 110 may include one or more rows of histograms 112. Each row of histograms 112 may correspond to a row 342 of pixels 108 in the region of interest of the image 106. In the case of bin interpolation, a single row of histograms 112 corresponding to a row 345 of cells 340 may be stored in the memory bank 110. In the case of spatial interpolation, multiple rows of histograms 112 may be stored in the memory bank 110.

The electronic device 102 may initiate 504 transfer of one or more histograms 112 between the memory bank 110 and local memory 114. For example, control logic 118 may receive a row and column number for each pixel 108 in the region of interest. The control logic 118 may determine which of the plurality of histograms 112 stored in the memory bank 110 are transferred to the local memory 114 based on the row and column number of an incoming pixel 108.

The control logic 118 may determine whether the one or more histograms 112 associated with the incoming pixel 108 are currently in the local memory 114. If the one or more associated histograms 112 are not currently in the local memory 114, then the control logic 118 initiates transfer of the one or more updated histograms 116 currently stored in the local memory 114 to the memory bank 110. The control logic 118 then initiates transfer of the one or more histograms 112 corresponding to the incoming pixel 108 from the memory bank 110 to the local memory 114.

The electronic device 102 may encode or decode histogram data being transferred between the memory bank 110 and the local memory 114. For example, the histograms 112 may be transferred from the memory bank 110 as a stream of bits. Data formatting logic 113 may decode this bit stream and output the histograms 112 as P bins 346 each of Q bits. For updated histograms 116 transferred from the local memory 114 to the memory bank 110, the data formatting logic 113 may encode the histogram data by packing all the bits from the updated histograms 116.

The electronic device 102 may find 506, for an incoming pixel 108, weights 122 of each bin for the one or more histograms 116 stored in the local memory 114. For example, using the pixel properties 452 of the incoming pixel 108, interpolation logic 120 may calculate the weights 122 for the histograms 112 corresponding to the incoming pixel 108.

The electronic device 102 may add 508 the weights 122 to the one or more histograms 112 stored in local memory 114. For example, the updating logic 115 may add 510 the calculated weights 122 to one or more bins 346 in one or more updated histograms 116 in the local memory 114. Therefore, the local memory 114 stores the one or more histograms 112 that are updated by the interpolation logic 120.

The electronic device 102 may transfer 510 the one or more updated histograms 116 from the local memory 114 to the memory bank 110. The electronic device 102 may replace 512 a corresponding one or more histograms 112 in the memory bank 110 with the one or more updated histograms 116.

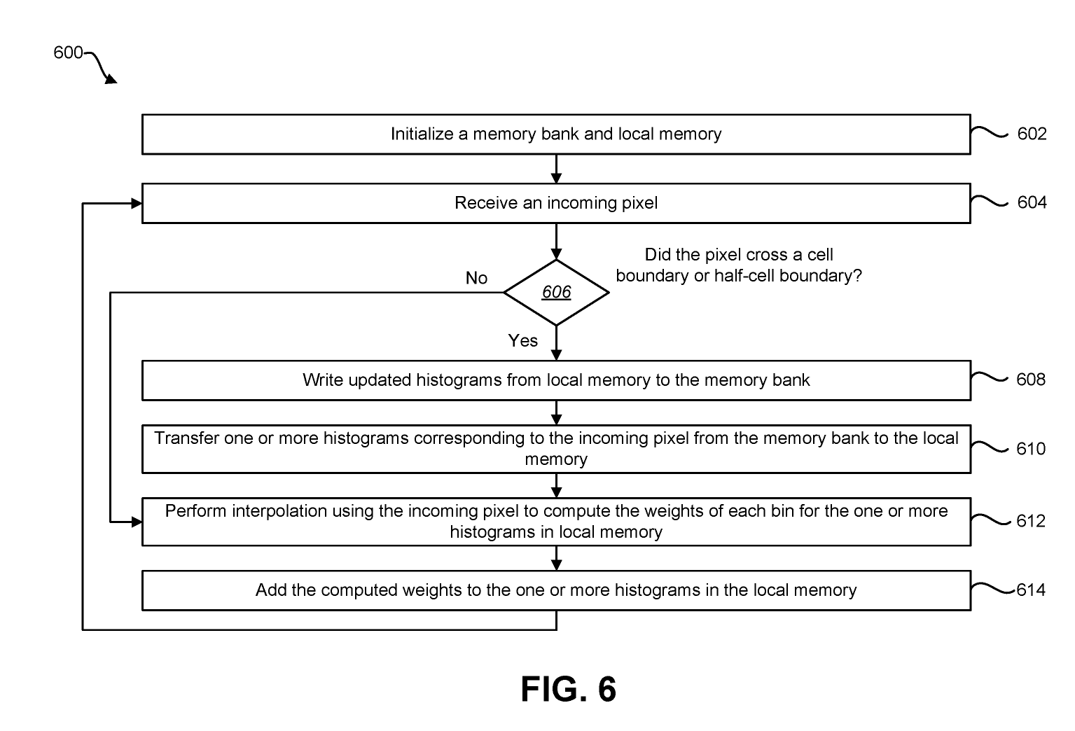

FIG. 6 is a flow diagram illustrating another method 600 for determining a histogram 112. The method 600 may be implemented by an electronic device 102. For example, the method 600 may be implemented by a programmable histogram block 104 of the electronic device 102.

The electronic device 102 may initialize 602 a memory bank 110 and local memory 114. For example, control logic 118 may initialize the memory bank 110 at image boundaries. Upon receiving a new image 106, the electronic device 102 may divide a region of interest of the image 106 into cells 340. The electronic device 102 may configure the memory bank 110 to store histograms 112 corresponding to a row 345 of cells 340. The electronic device 102 may set the histograms 112 in the memory bank 110 to zero.

The electronic device 102 may also initialize 602 the local memory 114. The electronic device 102 may allocate local memory 114 space based on a configured interpolation scheme. The electronic device 102 may set updated histograms 116 in the local memory 114 to zero.

The electronic device 102 may receive 604 an incoming pixel 108. Each pixel 108 may have a row and column number.

The electronic device 102 may determine 606 whether the pixel 108 crossed a cell boundary 347 (or half-cell boundary in the case of spatial interpolation). For example, if the pixel 108 is at the beginning of a new cell 340, then the pixel 108 crossed a cell boundary 347. In this case, this indicates that a new set of histograms 112 corresponding to the cell 340 of the incoming pixel 108 needs to be retrieved from the memory bank 110. The electronic device 102 may first write 608 updated histograms 116 in the local memory 114 to the memory bank 110.

The electronic device 102 may transfer 610 one or more histograms 112 corresponding to the incoming pixel 108 from the memory bank 110 to the local memory 114. For example, for bin interpolation, the electronic device 102 may transfer 610 a histogram 112 associated with the cell 340 of the pixel 108. For spatial interpolation, the electronic device 102 may transfer 610 the histogram 112 associated with the cell 340 of the pixel 108 and neighboring histograms 112.

In the case that the incoming pixel 108 crosses an image boundary 349 or image boundary, the electronic device 102 may read out the histograms 112 in the memory bank 110. In this case, the electronic device 102 outputs completed histograms 112 that will not need to be updated any further. The electronic device 102 may then re-initialize the row of histograms 112 in the memory bank 110 to zeros.

The electronic device 102 may perform 612 interpolation using the incoming pixel 108 to compute the weights 122 of each bin 346 for the one or more histograms 116 in the local memory 114. This may be accomplished as described in connection with FIG. 4. The electronic device 102 may add 614 the computed weights 122 to the one or more histograms 116 in the local memory 114.

The electronic device 102 may receive 604 the next incoming pixel 108. If the electronic device 102 determines 606 that an incoming pixel 108 did not cross a cell boundary 347 or half-cell boundary, then this indicates that the updated histogram(s) 116 in the local memory 114 correspond to the incoming pixel 108. In this case, the electronic device 102 may perform 612 interpolation without transferring histograms 112 or updated histograms 116.

FIG. 7 is a block diagram illustrating a hardware configuration for object detection using a programmable histogram block 704. This figure shows one implementation of how the histograms 112 generated by a programmable histogram block 704 may be used in an electronic device 702. This figure also illustrates how a programmable histogram block 704 may interface with other hardware blocks.

For an object detection use case, a gradient block 754 may receive image 706 data. The gradient block 754 may calculate gradients of the pixels 108 in the image 706. The gradients may be provided to a R2P normalization block 756, which finds the angle of the gradients. At this point, the pixels 108 may be characterized by a magnitude (M) and an angle θ, which may be passed to the programmable histogram block 704.

The programmable histogram block 704 may be implemented in accordance with the programmable histogram block 104, 204 described in connection with FIG. 1 and FIG. 2, respectively. The programmable histogram block 704 may output histogram data 236. This histogram data 236 may be normalized in a normalization block 758 before being passed to a classifier 760 that classifies an object in the image 706.

FIG. 8 is a block diagram illustrating a hardware configuration for color matching using a programmable histogram block 804. This figure shows one implementation of how the histograms 112 generated by a programmable histogram block 804 may be used in an electronic device 802. This figure also illustrates how a programmable histogram block 804 may interface with other hardware blocks.

A color matching use case may be used for color matching or object tracking. An image 806 may be provided to a color space converter 862 (e.g., CGC R2P color space converter), which converts the pixels 108 to saturation and hue. This pixel data is sent to the programmable histogram block 804, which may be implemented in accordance with the programmable histogram block 104, 204 described in connection with FIG. 1 and FIG. 2, respectively.

The programmable histogram block 804 may output histogram data 236. Once the histogram 112 of each cell 340 is generated, the histogram data 236 may be provided to a mode/moments block 864. A mode may be found, which is the dominant color, or moments may be found. The mode/moments block 864 may find a mathematical description of the histograms 112, which is provided to a matching block 866 for color matching.

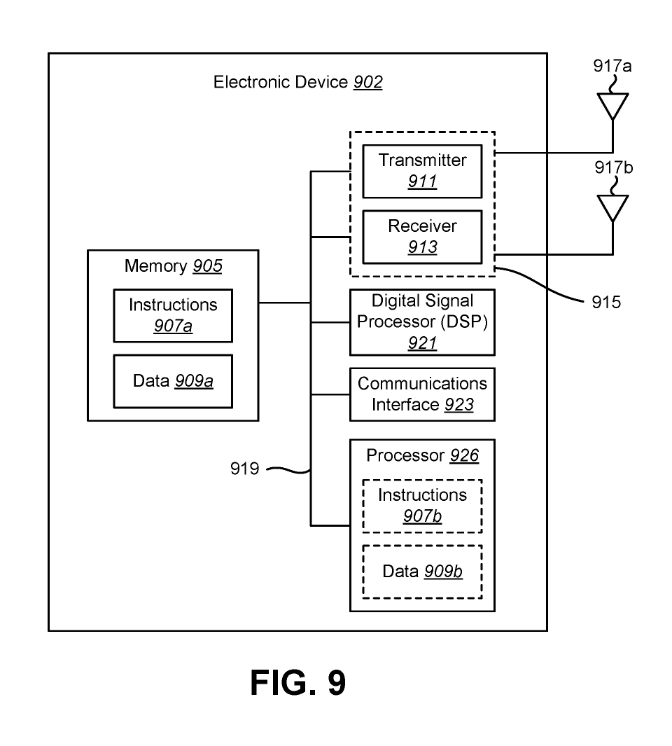

FIG. 9 illustrates certain components that may be included within an electronic device 902. The electronic device 902 may be or may be included within a camera, video camcorder, digital camera, cellular phone, smart phone, computer (e.g., desktop computer, laptop computer, etc.), tablet device, media player, television, automobile, personal camera, action camera, surveillance camera, mounted camera, connected camera, robot, aircraft, drone, unmanned aerial vehicle (UAV), healthcare equipment, gaming console, personal digital assistants (PDA), set-top box, etc.

The electronic device 902 includes a processor 926. The processor 926 may be a general purpose single- or multi-chip microprocessor (e.g., an Advanced RISC Machine (ARM)), a special purpose microprocessor (e.g., a digital signal processor (DSP)), a microcontroller, a programmable gate array, etc. The processor 926 may be referred to as a central processing unit (CPU). Although just a single processor 926 is shown in the electronic device 902, in an alternative configuration, a combination of processors (e.g., an ARM and DSP) could be used.

The electronic device 902 also includes memory 905. The memory 905 may be any electronic component capable of storing electronic information. The memory 905 may be embodied as random access memory (RAM), read-only memory (ROM), magnetic disk storage media, optical storage media, flash memory devices in RAM, on-board memory included with the processor, erasable programmable read-only (EPROM) memory, electrically erasable programmable read-only (EEPROM) memory, registers, and so forth, including combinations thereof.

Data 909a and instructions 907a may be stored in the memory 905. The instructions 907a may be executable by the processor 926 to implement one or more of the methods described herein. Executing the instructions 907a may involve the use of the data that is stored in the memory 905. When the processor 926 executes the instructions 907, various portions of the instructions 907b may be loaded onto the processor 926, and various pieces of data 909b may be loaded onto the processor 926.

The electronic device 902 may also include a transmitter 911 and a receiver 913 to allow transmission and reception of signals to and from the electronic device 902. The transmitter 911 and receiver 913 may be collectively referred to as a transceiver 915. One or multiple antennas 917a-b may be electrically coupled to the transceiver 915. The electronic device 902 may also include (not shown) multiple transmitters, multiple receivers, multiple transceivers and/or additional antennas.

The electronic device 902 may include a digital signal processor (DSP) 921. The electronic device 902 may also include a communications interface 923. The communications interface 923 may allow or enable one or more kinds of input and/or output. For example, the communications interface 923 may include one or more ports and/or communication devices for linking other devices to the electronic device 902. Additionally or alternatively, the communications interface 923 may include one or more other interfaces (e.g., touchscreen, keypad, keyboard, microphone, camera, etc.). For example, the communication interface 923 may enable a user to interact with the electronic device 902.

The various components of the electronic device 902 may be coupled together by one or more buses, which may include a power bus, a control signal bus, a status signal bus, a data bus, etc. For the sake of clarity, the various buses are illustrated in FIG. 9 as a bus system 919.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for determining a histogram, comprising:
storing a plurality of histograms in a memory bank, each histogram corresponding to a group of pixels in a region of interest of an image;
initiating transfer of one or more histograms between the memory bank and a local memory;
finding, for an incoming pixel, weights of each bin for the one or more histograms stored in the local memory;
adding the weights to the one or more histograms stored in the local memory;
transferring one or more updated histograms from the local memory to the memory bank; and
replacing a corresponding one or more histograms in the memory bank with the one or more updated histograms.

2. The method of claim 1, further comprising encoding or decoding histogram data being transferred between the memory bank and the local memory.

3. The method of claim 1, further comprising determining which of the plurality of histograms stored in the memory bank are transferred to the local memory based on a row and column number of the incoming pixel.

4. The method of claim 1, wherein the plurality of histograms stored in the memory bank comprise one or more rows of histograms, each row of histograms corresponding to a row of pixels in the region of interest of the image.

5. The method of claim 1, wherein when the incoming pixel is at a beginning of a current group of pixels, one or more updated histograms currently stored in the local memory are transferred to the memory bank and one or more histograms corresponding to the incoming pixel are transferred from the memory bank to the local memory.

6. The method of claim 1, wherein finding weights of each bin for the one or more histograms stored in the local memory comprises performing interpolation on the incoming pixel to compute the weights of each bin for the one or more histograms stored in local memory.

7. The method of claim 1, further comprising initializing the memory bank at image boundaries.

8. The method of claim 1, further comprising reading out histogram data in the memory bank at cell boundaries or image boundaries.

9. An apparatus for determining a histogram, comprising:
a memory bank that stores a plurality of histograms, each histogram corresponding to a group of pixels in a region of interest of an image; and
a processor having a local memory configured to receive one or more histograms from the memory bank, the processor being configured to:
initiate transfer of one or more histograms between the memory bank and the local memory;
find, for an incoming pixel, weights of each bin for the one or more histograms stored in the local memory; and
add the weights to the one or more histograms stored in the local memory, wherein the local memory transfers one or more updated histograms to the memory bank, and the memory bank replaces a corresponding one or more histograms with the one or more updated histograms.

10. The apparatus of claim 9, wherein the processor is further configured to encode or decode histogram data being transferred between the memory bank and the local memory.

11. The apparatus of claim 9, wherein the processor is configured to determine which of the plurality of histograms stored in the memory bank are transferred to the local memory based on a row and column number of the incoming pixel.

12. The apparatus of claim 9, wherein when the incoming pixel is at a beginning of a current group of pixels, the processor is configured to initiate transfer of the one or more updated histograms stored in the local memory to the memory bank.

13. The apparatus of claim 9, wherein when the incoming pixel is at a beginning of a current group of pixels, the processor is configured to initiate of the one or more histograms corresponding to the incoming pixel from the memory bank to the local memory.

14. The apparatus of claim 9, wherein the apparatus is adaptable to determine histograms of different cell size, number of bins, types of input, histogram weighting increments, or interpolation schemes.

15. The apparatus of claim 9, wherein the apparatus is used in color matching or object detection within the image.

16. An apparatus for determining a histogram, comprising:
means for storing a plurality of histograms in a memory bank, each histogram corresponding to a group of pixels in a region of interest of an image;
means for initiating transfer of one or more histograms between the memory bank and a local memory;
means for finding, for an incoming pixel, weights of each bin for the one or more histograms stored in the local memory;
means for adding the weights to the one or more histograms stored in the local memory;
means for transferring one or more updated histograms from the local memory to the memory bank; and
means for replacing a corresponding one or more histograms in the memory bank with the one or more updated histograms.

17. The apparatus of claim 16, further comprising means for encoding or decoding histogram data being transferred between the memory bank and the local memory.

18. The apparatus of claim 16, further comprising means for determining which of the plurality of histograms stored in the memory bank are transferred to the local memory based on a row and column number of the incoming pixel.

19. The apparatus of claim 16, wherein when the incoming pixel is at a beginning of a current group of pixels, one or more updated histograms currently stored in the local memory are transferred to the memory bank and one or more histograms corresponding to the incoming pixel are transferred from the memory bank to the local memory.

20. The apparatus of claim 16, wherein the means for finding weights of each bin for the one or more histograms stored in the local memory comprise means for performing interpolation on the incoming pixel to compute the weights of each bin for the one or more histograms stored in local memory.
